(19) United States
(12) Patent Application Publication
(10) Pub. No.: US 2016/0093245 A1
(43) Pub. Date: Mar. 31, 2016

(54) AMPLIFIER AND DISPLAY DRIVER INCLUDING AMPLIFIER

(71) Applicant: LAPIS Semiconductor Co., Ltd., Yokohama (JP)

(72) Inventor: Yukinobu WATANABE, Yokohama (JP)

(73) Assignee: LAPIS SEMICONDUCTOR CO., LTD., Yokohama (JP)

(21) Appl. No.: 14/867,693

(22) Filed: Sep. 28, 2015

(30) Foreign Application Priority Data
Sep. 29, 2014 (JP) 2014-197963

(51) Int. Cl. G09G 3/20

(52) U.S. Cl. CPC G09G 3/2092; G09G 2330/021

(57) ABSTRACT

When an amplifier supplies to a drive line a driving signal based on an input voltage corresponding to a data value indicated by input data, and feeds to an output line a current corresponding to a voltage value on the drive line, the amplifier precharges the drive line at start of increase or decrease of the input voltage. Furthermore, the amplifier stops the precharge when the data value indicated by the input data is smaller than a reference value, or when a difference between a data value at present and a data value immediately therebefore in a series of data values indicated by the input data is smaller than a reference difference value.

### BACKGROUND OF THE INVENTION

1. Field of the Invention

The present invention relates to amplifiers, and more particularly relates to an amplifier adopting a precharge scheme and to a display driver including the amplifier.

2. Description of the Related Art

A display driver for driving a display device, such as liquid crystal display panels, includes a plurality of amplifiers each configured to amplify gradation voltages corresponding to the luminance levels indicated by an input video signal and to apply the amplified gradation voltages as pixel drive voltages to each of the data lines of the liquid crystal display panel.

As one of the amplifiers for such a display driver, an amplifier adopting a precharge (hereinafter referred to as PC) scheme has been proposed to achieve high-speed operation (see, for example, Japanese Patent Application Laid-Open No. 2001-166741). In the PC scheme, a drive line for driving an output amplifier is provided with a precharge circuit, which precharges the drive line with a relatively high voltage immediately before the output amplifier amplifies a gradation voltage. As a consequence, a rising portion of the pixel drive voltage is generated by the precharged high voltage, and therefore when the gradation voltage is supplied thereafter, it becomes possible to rapidly increase the pixel drive voltage to a peak value.

However, in the amplifier adopting the above-described PC scheme, precharge needs to be performed at a voltage higher than the gradation voltage to achieve high-speed processing. This causes a problem of increased power consumption.

### SUMMARY OF THE INVENTION

An object of the present invention is to provide an amplifier capable of performing high-speed operation while suppressing power consumption, and to provide a display driver having the amplifier.

An amplifier according to the present invention is an amplifier for amplifying an input voltage corresponding to a data value indicated by input data and outputting the amplified voltage, the amplifier including: an input unit for generating a driving signal on the basis of the input voltage and supplying the generated driving signal to a drive line; an output unit for feeding to an output line a current corresponding to a voltage value of the drive line; a precharge unit for precharging the drive line; and a precharge control unit for controlling the precharge unit to perform the precharge at start of increase or decrease of the input voltage when the data value is equal to or more than a reference value and to stop the precharge when the data value is smaller than the reference value.

An amplifier according to the present invention is an amplifier for amplifying an input voltage corresponding to a series of data values indicated by input data and outputting the amplified voltage, the amplifier including: an input unit for generating a driving signal on the basis of the input voltage and supplying the generated driving signal to a drive line; an output unit for feeding to an output line a current corresponding to a voltage value of the drive line; a precharge unit for precharging the drive line; and a precharge control unit for controlling the precharge unit to perform the precharge at start of increase or decrease of the input voltage when a difference value between the data value at present and the data value immediately therebefore is equal to or more than a reference difference value, and to stop the precharge when the difference value is smaller than the reference difference value.

A display driver according to the present invention is a display driver, including a plurality of amplifiers, for individually amplifying each gradation voltage corresponding to each pixel data piece indicative of a luminance level of each pixel and applying each obtained pixel drive voltage to each data line of the display device, the amplifiers each including: an input unit for generating a driving signal on the basis of the gradation voltage and supplying the generated driving signal to a drive line; an output unit for feeding a current corresponding to a voltage value on the drive line to the data line through an output line; a precharge unit for precharging the drive line; and a precharge control unit for controlling the precharge unit to perform the precharge at start of increase or decrease of the gradation voltage when the luminance level indicated by the pixel data is equal to or more than a reference value and to stop the precharge when the luminance level is smaller than the reference value.

A display driver according to the present invention is a display driver, including a plurality of amplifiers, for individually amplifying each gradation voltage corresponding to each pixel data piece indicative of a luminance level of each pixel and applying each obtained pixel drive voltage to each data line of the display device, the amplifiers each including: an input unit for generating a driving signal on basis of the gradation voltage and supplying the generated driving signal to a drive line; an output unit for feeding a current corresponding to a voltage value on the drive line to the data line through an output line; a precharge unit for precharging the drive line; and a precharge control unit for controlling the precharge unit to perform the precharge at start of increase or decrease of the gradation voltage when a difference value between the luminance level indicated by the pixel data piece at present and the luminance level indicated by the pixel data piece one horizontal scanning period before is equal to or more than a reference difference value, and to stop the precharge when the difference value is smaller than the reference difference value.

The amplifier according to the present invention supplies to a drive line a driving signal based on an input voltage corresponding to a data value indicated by input data, and feeds to an output line a current corresponding to a voltage value on the drive line. By precharging the drive line at start of increase or decrease of the input voltage, the amplifier achieves high speed processing. In this operation, when the data value indicated by the input data is smaller than a reference value, or when a difference value between a data value at present and a data value immediately therebefore in a series of data values indicated by the input data is smaller than a reference difference value, the precharge is stopped to achieve reduction in power consumption.

Therefore, according to the present invention, it becomes possible to provide the amplifier capable of reducing power consumption and achieving high-speed operation.

### BRIEF DESCRIPTION OF THE DRAWINGS

FIG. 1 is a block diagram illustrating a configuration of a display apparatus 10 having a data driver 13 including amplifiers according to the present invention;

FIG. 2 is a block diagram illustrating an internal configuration of the data driver 13;

FIG. 3 is a circuit diagram illustrating a configuration of an amplifier AP₁;

FIG. 4 is a circuit diagram illustrating one example of an internal configuration of a PC control unit CNT;

FIG. 5 is a time chart depicting one example of the operation of the PC control unit CNT; and

FIG. 6 is a circuit diagram illustrating another example of the internal configuration of the PC control unit CNT.

### DETAILED DESCRIPTION OF THE EMBODIMENT

Hereinbelow, the embodiment of the present invention will be described in detail with reference to the accompanying drawings.

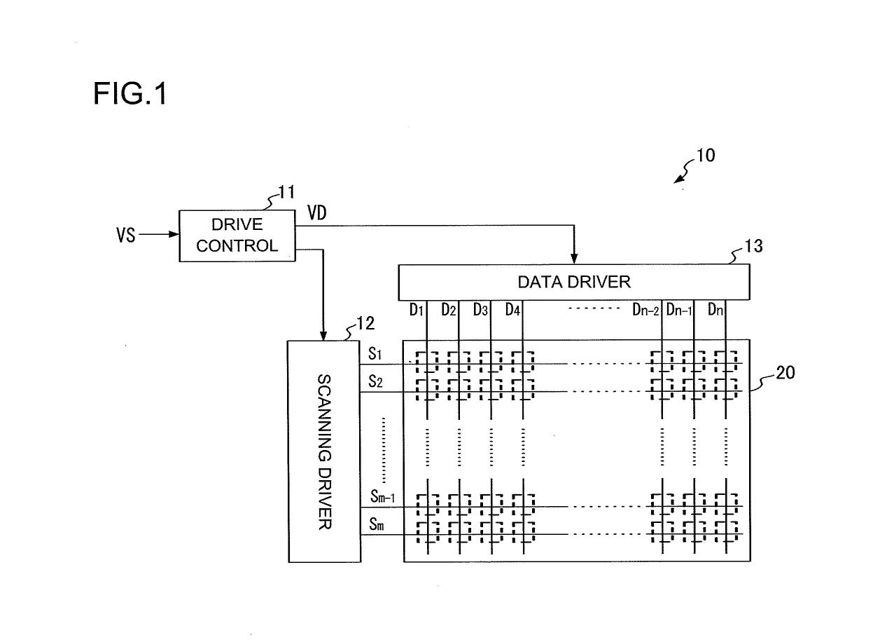

FIG. 1 is a block diagram illustrating a configuration of a display apparatus 10 having a data driver 13 including amplifiers according to the present invention. The display apparatus 10 illustrated in FIG. 1 includes a drive control unit 11, a scanning driver 12, a data driver 13, and a display device 20 constituted by a liquid crystal or organic EL panel.

The display device 20 includes m (m is a natural number of 2 or larger) horizontal scan lines S₁ to Sₘ each formed to extend in a horizontal direction on a two-dimensional screen and n (n is a natural number of 2 or larger) data lines D₁ to Dₙ each formed to extend in a perpendicular direction on the two-dimensional screen. Display cells that serve as pixels are each formed in a region of intersections between the horizontal scan lines and the data lines, i.e., in a region encircled with a dashed line in FIG. 1.

The drive control unit 11 generates a series of pixel data PD indicating the luminance level of each pixel in the form of, for example, six-bit data on the basis of an input video signal VS, and supplies a video data signal VD including the series of the pixel data PD to the data driver 13. The drive control unit 11 detects a horizontal synchronization signal from the input video signal VS, and supplies the detected signal to the scanning driver 12.

The scanning driver 12 generates a horizontal scanning pulse in synchronization with the horizontal synchronization signal supplied from the drive control unit 11, and sequentially applies the generated signal to each of the scanning lines S₁ to Sₘ of the display device 20 in an alternative manner.

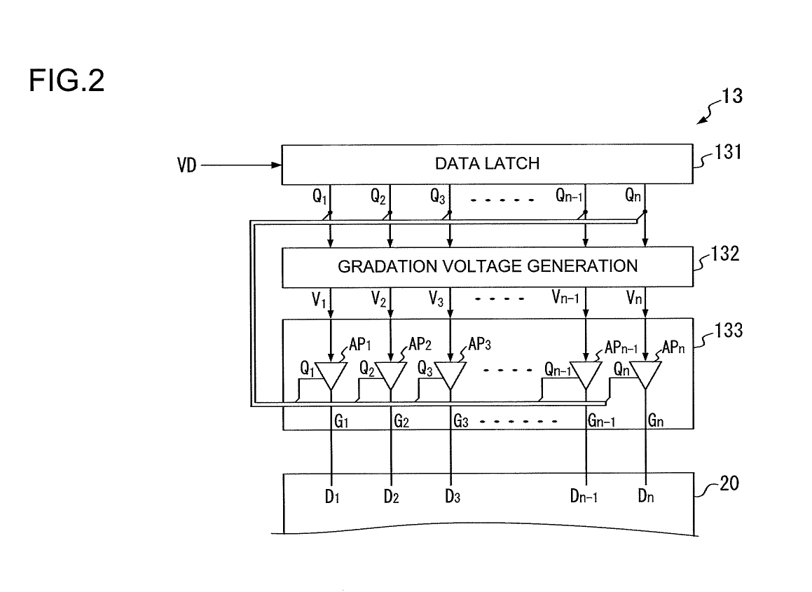

FIG. 2 is a block diagram illustrating the internal configuration of the data driver 13 used as a display driver. As illustrated in FIG. 2, the data driver 13 includes a data latch unit 131, a gradation voltage generation unit 132, and an output amplifier unit 133.

The data latch unit 131 sequentially takes in a series of the pixel data PD included in the video data signal VD supplied from the drive control unit 11. Whenever (n pieces of) pixel data PD for one horizontal scan line is taken in, the data latch unit 131 supplies the n pieces of pixel data PD as pixel data Q₁ to Qₙ to the gradation voltage generation unit 132 and to the output amplifier unit 133.

The gradation voltage generation unit 132 converts the pixel data Q₁ to Qₙ supplied from the data latch unit 131 into gradation voltages V₁ to Vₙ having voltage values corresponding to the luminance levels of the respective pixels, and supplies the gradation voltages V₁ to Vₙ to the output amplifier unit 133.

The output amplifier unit 133 includes amplifiers AP₁ to APₙ. The amplifiers AP₁ to APₙ individually amplify each of the gradation voltages V₁ to Vₙ into pixel drive voltages G₁ to Gₙ, and supply the obtained pixel drive voltages G₁ to Gₙ to each of the data lines D₁ to Dₙ of the display device 20. The amplifiers AP₁ to APₙ are each provided in association with each of the pixel data Q₁ to Qₙ (gradation voltages V₁ to Vₙ). The amplifiers AP₁ to APₙ are so-called PC-scheme differential amplifiers (operational amplifiers), which are configured to perform precharge inside themselves based on the pixel data Q and the gradation voltage V corresponding to their own amplifier AP. The amplifiers AP₁ to APₙ have the same internal configuration.

Hereinbelow, the configuration of the amplifier according to the present invention will be described by taking the amplifier AP₁ as an example.

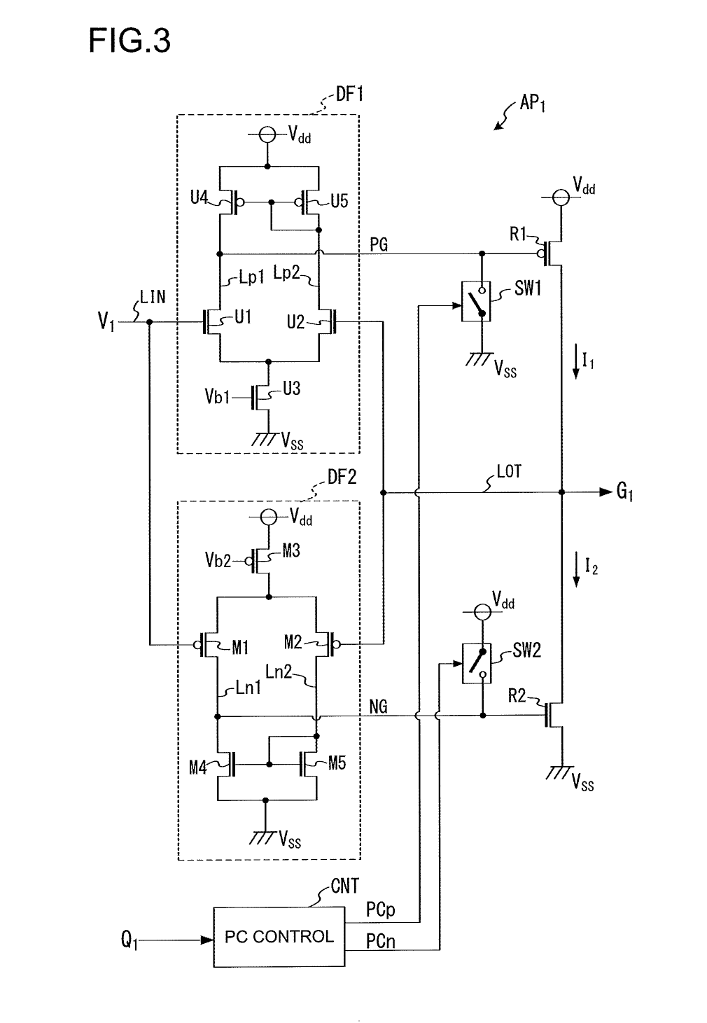

FIG. 3 is a circuit diagram illustrating the internal configuration of the amplifier AP' as an amplifier according to the present invention. As illustrated in FIG. 3, the amplifier AP₁ includes differential circuits DF1 and DF2, switch elements SW1 and SW2, a p-channel metal oxide semiconductor (MOS) output transistor R1, an n-channel MOS output transistor R2, and a PC control unit CNT.

The first differential circuit DF1 includes n-channel MOS transistors U1 to U3 and p-channel MOS transistors U4 and U5. The source terminals of the transistors U1 and U2, which constitute a differential pair, are each connected to the drain terminal of the transistor U3 serving as a current source. A bias voltage Vb1 for driving the differential circuit is applied to the gate terminal of the transistor 3, and a ground voltage Vss (for example, 0 bolts) is applied to the source terminal of the transistor 3.

The drain terminal of the transistor U1 is connected to the drain terminal of the transistor U4, to the gate terminal of the output transistor R1, and to the switch element SW1 through a line Lp1. The drain terminal of the transistor U2 is connected to the gate terminal of the transistor U4, and to the drain terminal and the gate terminal of the transistor U5 through a line Lp2. A supply voltage Vdd is applied to the source terminals of the transistors U4 and U5.

The gate terminal of the transistor U1, which is one transistor constituting a differential pair, is connected to an input line LIN, and the gate terminal of the transistor U2, which is the other transistor constituting the differential pair, is connected to an output line LOT.

The transistor U1 feeds to the line Lp1 a current corresponding to a gradation voltage V₁ supplied through the input line LIN. The transistor U2 feeds to the line Lp2 a current corresponding to a pixel drive voltage G₁ as an output voltage supplied through the output line LOT. The transistor U3 as a current source generates a composite current on the basis of the bias voltage Vb1. The composite current is generated by combining the current flowing through the line Lp1 and the current flowing through the line Lp2. The transistors U1 and U2 each feed currents to the lines Lp1 and Lp2, so that the sum of the current fed to the line Lp1 and the current fed to the line Lp2 is matched with the above-described composite current.

The thus-configured differential circuit DF1 generates an output voltage driving signal PG having a level corresponding to a difference value between the gradation voltage V₁ and the pixel drive voltage G₁ on the line Lp1 which serves as a first drive line.

The output transistor R1 sends out to the output line LOT an output current I₁ based on the output voltage driving signal PG.

The second differential circuit DF2 includes p-channel MOS transistors M1 to M3 and n-channel MOS transistors M4 and M5. The source terminals of the transistors M1 and M2, which constitute a differential pair, are each connected to the drain terminal of the transistor M3 serving as a current source. A bias voltage Vb2 for driving the differential circuit is applied to the gate terminal of the transistor M3, and a supply voltage Vdd is applied to the source terminal of the transistor M3.

The drain terminal of the transistor M1 is connected to the drain terminal of the transistor M4, to the gate terminal of the output transistor R2, and to the switch element SW2 through a line Ln1. The drain terminal of the transistor M2 is connected to the gate terminal of the transistor M4, and to the drain terminal and the gate terminal of the transistor M5 through a line Ln2. A ground voltage Vss is applied to the source terminals of the transistors M4 and M5.

The gate terminal of the transistor M1, which is one transistor constituting a differential pair, is connected to the input line LIN, and the gate terminal of the transistor M2, which is the other transistor constituting the differential pair, is connected to the output line LOT.

The transistor M1 feeds to the line Ln1 a current corresponding to the gradation voltage V₁ supplied through the input line LIN. The transistor M2 feeds to the line Ln2 a current corresponding to the pixel drive voltage G₁ as an output voltage supplied through the output line LOT. The transistor M3 as a current source generates a composite current on the basis of the bias voltage Vb2. The composite current is generated by combining the current flowing through the line Ln1 and the current flowing through the line Ln2. The transistors M1 and M2 each feed currents to the lines Ln1 and Ln2, so that the sum of the current fed to the line Ln1 and the current fed to the line Ln2 is matched with the above-described composite current.

The thus-configured differential circuit DF2 generates an output voltage driving signal NG having a level corresponding to a difference value between the gradation voltage V₁ and the pixel drive voltage G₁ on the line Ln1 which serves as a second drive line. The output voltage driving signal NG has a phase inverted from the above-described output voltage driving signal PG.

The output transistor R2 extracts an output current I₂ based on the output voltage driving signal NG from the output line LOT. Therefore, a pixel drive voltage G₁, which has a voltage value corresponding to the current value obtained by subtracting the output current I₂ from the output current I₁ sent out by the aforementioned output transistor R1, is generated on the output line LOT.

In short, the amplifier illustrated in FIG. 3 is a differential amplifier of a so-called voltage follower, which amplifies an input voltage (V₁) with a gain of 1 by performing push-pull driving of two output transistors (R1, R2) by using two independent differential circuits (DF1, DF2).

To implement high-speed operation, the amplifier illustrated in FIG. 3 includes the switch elements SW1 and SW2 provided as a precharge unit and the PC control unit CNT provided as a precharge control unit.

The Line Lp1 is connected to one end of the switch element SW1, and a ground voltage Vss is applied to the other end of the switch element SW1. The switch element SW1 is turned on while the logic level of a rising precharge signal PCp supplied from the PC control unit CNT is 1, and is turned off while the logic level is 0, for example. The switch element SW1 applies the ground voltage Vss to the line Lp1 only when it is turned on.

The line Ln1 is connected to one end of the switch element SW2, and a supply voltage Vdd is applied to the other end of the switch element SW2. The switch element SW2 is turned on while the logic level of a falling precharge signal PCn supplied from the PC control unit CNT is 1 and is turned off while the logic level is 0, for example. The switch element SW2 applies the supply voltage Vdd to the line Ln1 only when it is turned on.

The PC control unit CNT generates a rising precharge signal PCp indicative of whether or not to execute rising precharge, on the basis of the pixel data Q₁, and supplies the generated signal to the switch element SW1. For example, the PC control unit CNT generates a rising precharge signal PCp of logic level 1 to execute rising precharge, and generates a rising precharge signal PCp of logic level 0 to stop the rising precharge.

The PC control unit CNT generates a falling precharge signal PCn indicative of whether or not to execute falling precharge, on the basis of the pixel data Q₁, and supplies the generated signal to the switch element SW2. For example, the PC control unit CNT generates a falling precharge signal PCn of logic level 1 to execute falling precharge, and generates a falling precharge signal PCn of logic level 0 to stop the falling precharge.

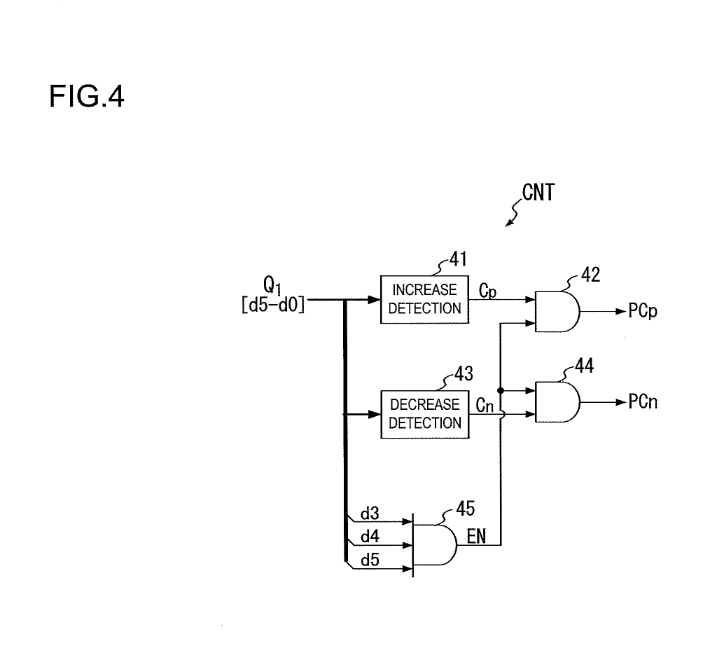

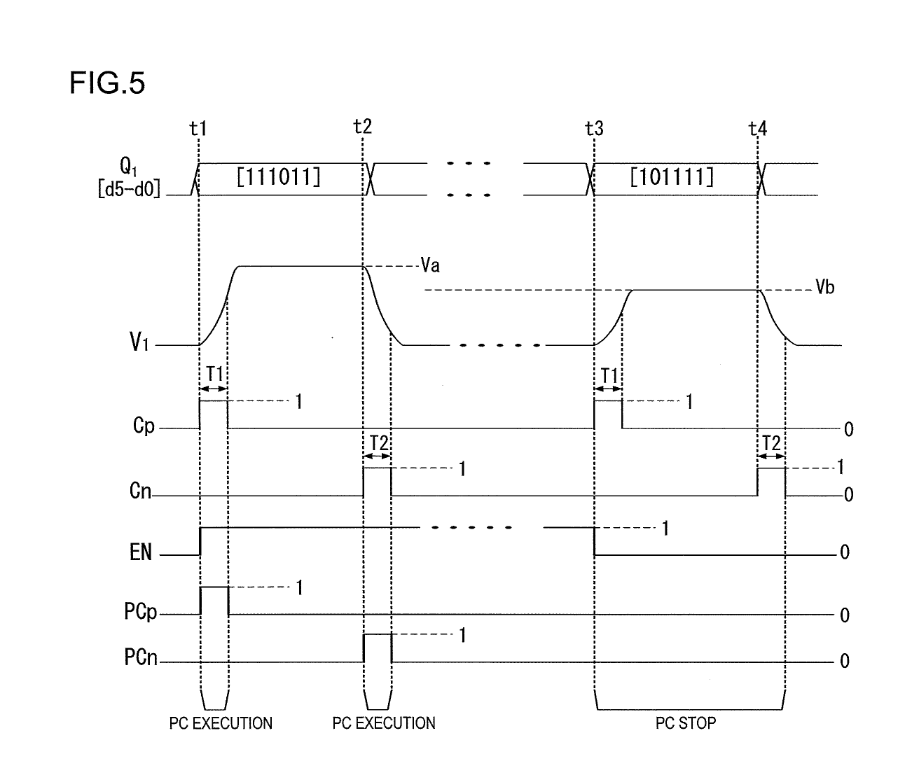

FIG. 4 is a circuit diagram illustrating one example of the internal configuration of the PC control unit CNT. An increase detection unit 41 generates a rising precharge signal Cp, which is at logic level 1 only during a specified voltage rising period T1 upon detection of the start of increase in the luminance level indicated by the pixel data Q₁. The rising precharge signal Cp is at logic level 0 in other periods. More specifically, the increase detection unit 41 generates a rising precharge signal Cp of logic level 1 which prompts execution of precharge only during the voltage rising period T1 at each voltage rising portion of the gradation voltage V₁, that is, at the time of t1 and t3 illustrated in FIG. 5, for example. The increase detection unit 41 supplies the rising precharge signal Cp to an AND gate 42.

A decrease detection unit 43 generates a falling precharge signal Cn, which is at logic level 1 only during a specified voltage falling period T2 upon detection of the start of decrease in the luminance level indicated by the pixel data Q₁. The falling precharge signal Cn is at logic level 0 in other periods. More specifically, the decrease detection unit 43 generates a falling precharge signal Cn of logic level 1 which prompts execution of precharge only during the voltage falling period T2 at each voltage falling portion of the gradation voltage V₁, that is, at the time of t2 and t4 illustrated in FIG. 5, for example. The decrease detection unit 43 supplies the falling precharge signal Cn to an AND gate 44.

The AND gate 45 generates a PC enable signal EN of logic level 1 that represents an enabled state, when all the upper three bits [d5, d4, d3], among six bits [d5 to d0] of the pixel data Q₁ that represent the luminance level, indicate the logic level 1, for example. The AND gate 45 generates a PC enable signal EN of logic level 0 that represents a disabled state in other cases. More specifically, the AND gate 45 generates the PC enable signal EN of logic level 1 that indicates precharge is valid, only when the luminance level indicated by the pixel data Q₁ corresponding to the gradation voltage V₁ is equal to or more than a specified reference luminance, that is, when the bits d5 to d0 indicate [111000] or more, for example. The AND gate 45 supplies the generated PC enable signal EN to the AND gates 42 and 44.

Only when the PC enable signal EN is at logic level 1 that represents the enabled state, the AND gate 42 supplies to the switch element SW1 the rising precharge signal Cp supplied from the increase detection unit 41 as a rising precharge signal PCp. When the PC enable signal EN is at logic level 0 that represents the disabled state, the AND gate 42 supplies to the switch element SW1 the rising precharge signal PCp fixed to the logic level 0 that indicates stop of the rising precharge.

Only when the PC enable signal EN is at logic level 1 that represents the enabled state, the AND gate 44 supplies to the switch element SW2 the falling precharge signal Cn supplied from the decrease detection unit 43 as a falling precharge signal PCn. When the PC enable signal EN is at logic level 0 that represents the disabled state, the AND gate 44 supplies to the switch element SW2 the falling precharge signal PCn fixed to the logic level 0 that indicates stop of the falling precharge.

Hereinbelow, the precharge operation by the PC control unit CNT and the switch elements SW1 and SW2 will be described.

A description is first given of the operation to be performed when pixel data Q₁ and a gradation voltage V₁ corresponding to the luminance level indicated by the pixel data Q₁ are supplied to the amplifier AP' with reference to FIG. 5. The pixel data Q₁ indicates a luminance level equal to or more than a specified reference luminance, that is, for example, the bits d5 to d0 of the pixel data Q₁ indicate [111011].

When the gradation voltage V₁ starts to increase at time t1 as illustrated in FIG. 5, the increase detection unit 41 supplies to the AND gate 42 a rising precharge signal Cp of logic level 1 only during the voltage rising period T1. In this case, since all the upper three bits (d5, d4, d3) among the bits d5 to d0 of the above-stated pixel data Q₁ indicate the logic level 1, the AND gate 45 supplies the PC enable signal EN of logic level 1 that indicates precharge is valid to the AND gates 42 and 44 as illustrated in FIG. 5. Therefore, the PC control unit CNT supplies to the switch element SW1 the rising precharge signal PCp of logic level 1 only during the voltage rising period T1 as illustrated in FIG. 5. In response to the rising precharge signal PCp, the switch element SW1 is turned on, so that the ground voltage Vss is applied to the gate terminal of the output transistor R1 over the voltage rising period T1.

As a consequence, the output transistor R1 is turned on, so that the supply voltage Vdd is applied to the output line LOT over the voltage rising period T1 (rising precharge). The value of the supply voltage Vdd is equal to or more than a maximum voltage value that the gradation voltage V₁ can take. Therefore, the rising precharge can provide a steep rising portion to the voltage value in the pixel drive voltage G₁. More specifically, the rising precharge increases a voltage increase amount per unit time in a rising portion of the voltage value of the pixel drive voltage G₁ as compared with the case where the output transistor R1 is driven on the basis of the output voltage driving signal PG generated in the differential circuit DF1.

Then, the voltage value of the gradation voltage V₁ reaches a voltage value Va corresponding to the luminance level indicated by the pixel data Q₁ and then starts to decrease at time t2 illustrated in FIG. 5. In response to the decrease, the decrease detection unit 43 supplies to the AND gate 44 the falling precharge signal Cn of logic level 1 only during the voltage fall period T2. Therefore, the PC control unit CNT supplies to the switch element SW2 the falling precharge signal PCn of logic level 1 only during the voltage fall period T2 as illustrated in FIG. 5. In response to the falling precharge signal PCn, the switch element SW2 is turned on, so that the supply voltage Vdd is applied to the gate terminal of the output transistor R2 over the voltage fall period T2.

As a consequence, the output transistor R2 is turned on, so that the ground voltage Vss is applied to the output line LOT over the voltage fall period T2 (falling precharge). Therefore, the falling precharge can provide a steep falling portion to the voltage value in the pixel drive voltage G₁. More specifically, the falling precharge increases a voltage decrease amount per unit time in a falling portion of the voltage value in the pixel drive voltage G₁ as compared with the case where the output transistor R2 is driven on the basis of the output voltage driving signal NG generated in the differential circuit DF2.

A description is now given of the operation to be performed when pixel data Q₁ and a gradation voltage V₁ corresponding to the luminance level indicated by the pixel data Q₁ are supplied to the amplifier AP₁ with reference to FIG. 5. The pixel data Q₁ indicates a luminance level equal to or more than a specified reference luminance, that is, for example, the bits d5 to d0 of the pixel data Q₁ indicate [101111].

When the gradation voltage V₁ starts to increase at time t3 as illustrated in FIG. 5, the increase detection unit 41 supplies to the AND gate 42 a rising precharge signal Cp of logic level 1 only during the voltage rising period T1. Then, the voltage value of the gradation voltage V₁ reaches a voltage value Vb corresponding to the luminance level indicated by the pixel data Q₁ and then starts to decrease at time t4 illustrated in FIG. 5. In response to the decrease, the decrease detection unit 43 supplies to the AND gate 44 a falling precharge signal Cn of logic level 1 only during the voltage fall period T2.

Since the upper three bits (d5, d4, d3) of the above-stated pixel data Q₁ includes a bit expressing the logic level 0, the AND gate 45 supplies a PC enable signal EN of logic level 0 that indicates precharge is invalid to the AND gates 42 and 44 as illustrated in FIG. 5.

Therefore, during this period of time, the PC control unit CNT supplies to the switch elements SW1 and SW2 the rising precharge signal PCp and the falling precharge signal PCn of logic level 0 that prompt switch-off as illustrated in FIG. 5.

Therefore, precharge is not performed when the gradation voltage V₁, which corresponds to the luminance level less than the specified reference luminance, i.e., the luminance level expressed as [101111] by the bits d5 to d0 for example, is supplied to the amplifier AP₁.

More specifically, when the luminance level indicated by the pixel data Q₁ is low, the peak value of the pixel drive voltage G₁ corresponding to that luminance level becomes lower than that in the case where the luminance lever is high. As a result, a voltage rising section in the pixel drive voltage G₁ becomes shorter.

Accordingly, when the luminance level indicated by the pixel data Q₁ is equal to or more than the reference luminance, the amplifier illustrated in FIG. 3 performs precharge to achieve high-speed operation. When the luminance level indicated by the pixel data Q is lower than the reference luminance, the amplifier of FIG. 3 stops precharge operation to reduce power consumption and heat generation caused by the precharge operation.

Therefore, the amplifier according to the present invention can perform high-speed operation while suppressing power consumption.

In the above-described embodiment, the upper three bits (d5, d4, d3) in the pixel data Q are used as a reference luminance that is a threshold value for determining whether or not to perform the precharge. However, the present invention is not limited to this configuration. For example, precharge may be executed only when the logic level of the upper two bits (d5, d4), or the upper one bit (d5), or a group of all the upper r bits (r is a natural number smaller than the total number of bits of pixel data Q) is 1 (or 0), and precharge may be stopped in other cases.

In the PC control unit CNT in the above-described embodiment, precharge is executed only when the level of all the upper bit group in the pixel data Q₁ is 1 (or 0). However, the present invention is not limited to this configuration. For example, the precharge may be executed only when a difference between a data value at present and a data value immediately therebefore in the pixel data Q₁ is larger than a specified value.

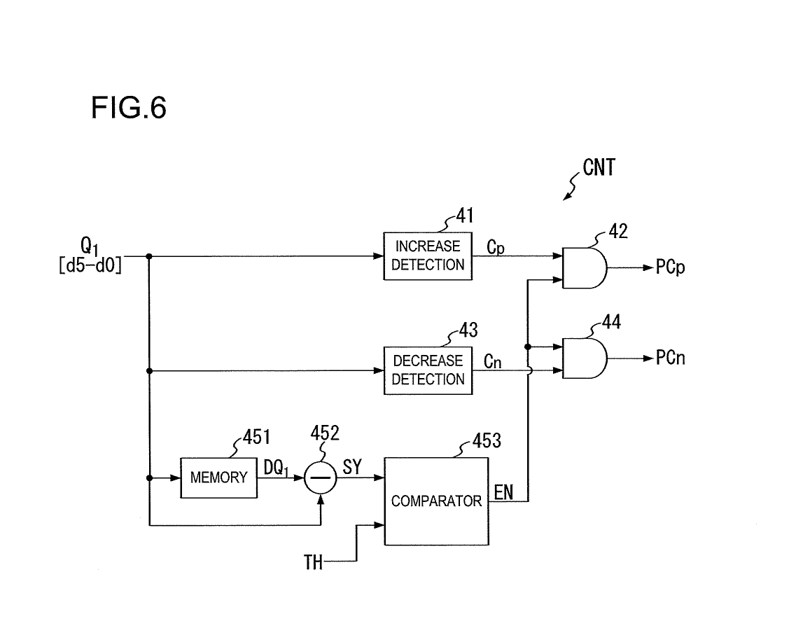

FIG. 6 is a circuit diagram illustrating another example of the internal configuration of the PC control unit CNT made in view of this point. The configuration illustrated in FIG. 6 is similar to the configuration illustrated in FIG. 4 except that a memory 461, a subtractor 452, and a comparator 453 are adopted in place of the AND gate 45.

Hereinbelow, the operation of the PC control unit CNT in the configuration illustrated in FIG. 6 will be described by paying attention to the memory 451, the subtractor 452, and the comparator 453.

The memory 451 takes in pixel data Q₁, delays the pixel data Q₁ by one horizontal scanning period, and supplies the delayed data as delayed pixel data DQ₁ to the subtractor 452. That is, the delay pixel data DQ₁ indicative of a data value immediately before the present data, which is indicated by the pixel data Q₁, is supplied to the subtractor 452. The subtractor 452 calculates a difference between a present data value expressed by, for example, six bits (d5 to d0) in the pixel data Q₁ and an immediately previous data value indicated by the delay pixel data DQ₁, and supplies the calculated difference to the comparator 453 as a luminance difference value SY. The comparator 453 compares the luminance difference value SY with a specified reference difference value TH in magnitude. When the luminance difference value SY is larger than the reference difference value TH, the comparator 453 supplies a PC enable signal EN of logic level 1 that indicates precharge is valid to the AND gates 42 and 44. When the luminance difference value SY is equal to or smaller than the reference difference value TH, the comparator 453 supplies a PC enable signal EN of logic level 0 that indicates precharge is invalid to the AND gates 42 and 44.

In other words, when the pixel drive voltage G₁ corresponding to the pixel data Q₁ is generated, the pixel drive voltage G₁ can immediately reach a desired voltage value without execution of the precharge if the difference between the luminance level indicated by the pixel data Q₁ at present and the luminance level indicated by the pixel data Q₁ one horizontal scanning period before is small.

Accordingly, in the PC control unit CNT having a configuration illustrated in FIG. 6, precharge operation is stopped if the luminance difference value SY between the data value at present indicated by the pixel data Q₁ and the data value one horizontal scanning period before is smaller than the reference difference value TH. As a consequence, even when the luminance level indicated by the pixel data Q₁ is higher than the reference luminance, the precharge operation is stopped if the difference between the data value at present indicated by the pixel data Q₁ and the data value immediately therebefore is small thereafter.

Therefore, when the configuration illustrated in FIG. 6 is adopted for the PC control unit CNT, power consumption and heat generation can further be suppressed as compared with the case where the configuration illustrated in FIG. 4 is adopted.

Although the PC control unit CNT is provided in each of the amplifiers AP₁ to APₙ in the above embodiment, the PC control unit CNT may be provided outside these amplifiers AP₁ to APₙ. Only some modules in the PC control unit CNT illustrated in FIG. 4 or FIG. 6, such as the increase detection unit, the decrease detection unit 43, and the memory 451, may be provided outside the amplifiers AP₁ to APₙ.

Although the amplifier according to the present invention has been described as the amplifier (AP₁ to APₙ) for the display driver (13), the amplifier may be used for amplifying signals for apparatuses other than the display driver.

In short, the amplifiers illustrated in FIGS. 3 to 6 can be used for amplifying signals of various apparatuses as an amplifier for amplifying an input voltage (V) corresponding to the data value (luminance level) indicated by input data (Q). The amplifier includes input units (DF1, DF2) for generating a driving signal (PG, NG) on the basis of an input voltage and supplying the generated signals to a drive line (Lp1), output units (R1, R2) for feeding currents (I₁, I₂) corresponding to the voltage value on the drive line to an output line (LOT), precharge units (SW1, SW2) for precharging the drive line, and a precharge control unit (CNT). The precharge control unit having a configuration illustrated in FIG. 4 controls the precharge units to execute precharge at start of increase or decrease of the input voltage when the above-stated data value is equal to or more than a reference value, and to stop the precharge when the data value is smaller than a reference value. The precharge control unit having a configuration illustrated in FIG. 6 controls the precharge unit to execute precharge at start of increase or decrease of an input voltage when a difference value (SY) between a data value (Q₁) at present and a data value (DQ₁) immediately therebefore is equal to or more than a reference difference value (TH), and to stop the precharge when the difference value is smaller than the reference difference value.

This application is based on a Japanese Patent Application No. 2014-197963 which is hereby incorporated by reference.

What is claimed is:

1. An amplifier for amplifying an input voltage corresponding to a data value indicated by input data and outputting the amplified voltage, the amplifier comprising:
an input unit for generating a driving signal on the basis of the input voltage and supplying the generated driving signal to a drive line;
an output unit for feeding to an output line a current corresponding to a voltage value of the drive line;
a precharge unit for precharging the drive line; and
a precharge control unit for controlling the precharge unit to perform the precharge at start of increase or decrease of the input voltage when the data value is equal to or more than a reference value and to stop the precharge when the data value is smaller than the reference value.

2. The amplifying circuit according to claim 1, wherein
the input unit includes a differential circuit for generating a difference between the input voltage and a voltage of the output line as the driving signal,
the output unit includes a MOS transistor having a gate terminal connected to the drive line, a drain terminal connected to the output line, and a source terminal having a supply voltage or a ground voltage applied thereto, and
the precharge unit precharges the drive line by applying the ground voltage or the supply voltage to the drive line at the start of increase or decrease of the input voltage.

3. An amplifier for amplifying an input voltage corresponding to a series of data values indicated by input data and outputting the amplified voltage, the amplifier comprising:
an input unit for generating a driving signal on the basis of the input voltage and supplying the generated driving signal to a drive line;
an output unit for feeding to an output line a current corresponding to a voltage value of the drive line;
a precharge unit for precharging the drive line; and
a precharge control unit for controlling the precharge unit to perform the precharge at start of increase or decrease of the input voltage when a difference value between the data value at present and the data value immediately therebefore is equal to or more than a reference difference value, and to stop the precharge when the difference value is smaller than the reference difference value.

4. The amplifying circuit according to claim 3, wherein
the input unit includes a differential circuit for generating a difference between the input voltage and a voltage of the output line as the driving signal,
the output unit includes a MOS transistor having a gate terminal connected to the drive line, a drain terminal connected to the output line, and a source terminal having a supply voltage or a ground voltage applied thereto, and
the precharge unit precharges the drive line by applying the ground voltage or the supply voltage to the drive line at the start of increase or decrease of the input voltage.

5. A display driver, including a plurality of amplifiers, for individually amplifying each gradation voltage corresponding to each pixel data piece indicative of a luminance level of each pixel and applying each obtained pixel drive voltage to each data line of the display device, the plurality of amplifiers each comprising:
an input unit for generating a driving signal on the basis of the gradation voltage and supplying the generated driving signal to a drive line;
an output unit for feeding a current corresponding to a voltage value on the drive line to the data line through an output line;
a precharge unit for precharging the drive line; and
a precharge control unit for controlling the precharge unit to perform the precharge at start of increase or decrease of the gradation voltage when the luminance level indicated by the pixel data is equal to or more than a reference value and to stop the precharge when the luminance level is smaller than the reference value.

6. The display driver according to claim 5, wherein
the input unit includes a differential circuit for generating a difference between the input voltage and the pixel drive voltage as the driving signal,
the output unit includes a MOS transistor having a gate terminal connected to the drive line, a drain terminal connected to the output line, and a source terminal having a supply voltage or a ground voltage applied thereto, and
the precharge unit precharges the drive line by applying the ground voltage or the supply voltage to the drive line at the start of increase or decrease of the input voltage.

7. A display driver, including a plurality of amplifiers, for individually amplifying each gradation voltage corresponding to each pixel data piece indicative of a luminance level of each pixel and applying each obtained pixel drive voltage to each data line of the display device,
the amplifiers each including:
an input unit for generating a driving signal on basis of the gradation voltage and supplying the generated driving signal to a drive line;
an output unit for feeding a current corresponding to a voltage value on the drive line to the data line through an output line;
a precharge unit for precharging the drive line; and
a precharge control unit for controlling the precharge unit to perform the precharge at start of increase or decrease of the gradation voltage when a difference value between the luminance level indicated by the pixel data piece at present and the luminance level indicated by the pixel data piece one horizontal scanning period before is equal to or more than a reference difference value, and to stop the precharge when the difference value is smaller than the reference difference value.

8. The display driver according to claim 7, wherein
the input unit includes a differential circuit for generating a difference between the input voltage and the pixel drive voltage as the driving signal,
the output unit includes a MOS transistor having a gate terminal connected to the drive line, a drain terminal connected to the output line, and a source terminal having a supply voltage or a ground voltage applied thereto, and
the precharge unit precharges the drive line by applying the ground voltage or the supply voltage to the drive line at the start of increase or decrease of the input voltage.
